(19) United States
(12) Patent Application Publication
(10) Pub. No.: US 2018/0071945 A1
(43) Pub. Date: Mar. 15, 2018

(54) METHOD FOR PRODUCING SINGLE- OR MULTI-LAYER LIGNOCELLULOSE MATERIALS USING TRIALKYL PHOSPHATE

(71) Applicant: BASF SE, Ludwigshafen (DE)

(72) Inventor: Stephan WEINKÖTZ, Neustadt (DE)

(21) Appl. No.: 15/562,078

(22) PCT Filed: Mar. 17, 2016
(86) PCT No.: PCT/EP2016/055790

§ 371 Date: Sep. 27, 2017

(30) Foreign Application Priority Data
Mar. 27, 2015 (JP) 15161456.7

(51) Int. Cl. B27N 3/00; C08L 97/02; C08K 5/521; C08L 61/24; C08L 75/04

(52) U.S. Cl. CPC B27N 3/002; C08L 97/02; C08L 75/04; C08L 61/24; C08K 5/521

(57) ABSTRACT

The present invention relates to a process for the discontinuous or continuous, preferably continuous, production of single-layer or multilayer lignocellulosic materials, comprising the process steps of
v) mixing the components of the individual layers,
x) scattering the mixture(s) produced in process step i) to form a mat,
xi) precompacting the scattered mat, and
xii) hot pressing the precompacted mat,
which comprises, in process step i)
   for the core of multilayer lignocellulosic materials or for single-layer lignocellulosic materials, mixing the lignocellulose particles (component LCP-1) with
u) 0 to 25 wt % of expanded polymer particles having a bulk density in the range from 10 to 150 kg/m³ (component A),
v) 0.05 to 1.39 wt % of binders selected from the group of organic isocyanates having at least two isocyanate groups (component B),
w) 3 to 20 wt % of binders selected from the group of amino resins (component C),
x) 0 to 5 wt % of curing agents (component D),
y) 0 to 5 wt % of additives (component E),
z) 0.01 to 10 wt % of trialkyl phosphate (TAP) (component F), and
   for the outer layers of multilayer lignocellulosic materials, mixing the lignocellulose particles (component LCP-2) with
aa) 1 to 30 wt % of binders selected from the group of amino resins, phenolic resins, organic isocyanates having at least two isocyanate groups, protein-based binders, and other polymer-based binders (component G),
bb) 0 to 5 wt % of curing agents (component H),
cc) 0 to 5 wt % of additives (component I), and
dd) 0 to 10 wt % of trialkyl phosphate (TAP) (component J).

The present invention relates to a process for producing single-layer or multilayer lignocellulosic materials using trialkyl phosphate.

Known from DE-A-33 28 662 are binder systems based on polyisocyanates and also binder combinations with conventional binders, such as amino resins, for the production of pressed materials, such as particle board, these systems and combinations comprising latent catalysts formed by reaction of primary, secondary and/or tertiary amines with esters of phosphorus acids. One of the possible esters listed is triethyl phosphate (TEP). The TEP is reacted with an amine, rather than being added as it is to the binder system.

This process has procedural disadvantages.

It was an object of the present invention, accordingly, to remedy the disadvantages identified above.

Found accordingly has been a new and improved process for the discontinuous or continuous, preferably continuous, production of single-layer or multilayer lignocellulosic materials, comprising the process steps of)
i) mixing the components of the individual layers,
ii) scattering the mixture(s) produced in process step i) to form a mat,
iii) precompacting the scattered mat, and
iv) hot pressing the precompacted mat,
which comprises, in process step i)
   for the core of multilayer lignocellulosic materials or for single-layer lignocellulosic materials, mixing the lignocellulose particles (component LCP-1) with
a) 0 to 25 wt % of expanded polymer particles having a bulk density in the range from 10 to 150 kg/m³ (component A),
b) 0.05 to 1.39 wt % of binders selected from the group of organic isocyanates having at least two isocyanate groups (component B),
c) 3 to 20 wt % of binders selected from the group of amino resins (component C),
d) 0 to 5 wt % of curing agents (component D),
e) 0 to 5 wt % of additives (component E),
f) 0.01 to 10 wt % of trialkyl phosphate (TAP) (component F), and for the outer layers of multilayer lignocellulosic materials, mixing the lignocellulose particles (component LCP-2) with
g) 1 to 30 wt % of binders selected from the group of amino resins, phenolic resins, organic isocyanates having at least two isocyanate groups, protein-based binders, and other polymer-based binders (component G),
h) 0 to 5 wt % of curing agents (component H),
i) 0 to 5 wt % of additives (component I), and
j) 0 to 10 wt % of trialkyl phosphate (TAP) (component J),
   and also found have been single-layer or multilayer lignocellulosic materials produced in accordance with the above process.

The figures in wt % of components A) to F) and G) to J) are the weights of the respective component relative to the dry weight of the lignocellulose particles. The dry weight of the lignocellulose particles is the weight of the lignocellulose particles without the water they include. It is also referred to as the atro weight (absolut trocken—absolutely dry). Where components A) to F) and G) to J) are used in aqueous form, in other words, for example, in the form of aqueous solutions or emulsions, the water is disregarded in the stated weights. For example, when using 5 kg of 30% strength ammonium nitrate solution as component H) per 100 kg of lignocellulose particles (dry weight), the amount of ammonium nitrate is 1.5 wt %. In the case of amino or phenolic resins, the weight is based on the solids content. The solids content of amino or phenolic resins is determined by weighing out 1 g of the resin into a weighing boat, drying it in a drying cabinet at 120° C.+/−2 K for two hours, and weighing the residue after conditioning to room temperature in a desiccator (Zeppenfeld, Grunwald, Klebstoffe in der Holz—und Möbelindustrie, DRW Verlag, 2nd edition, 2005, page 286).

Additionally, all of the layers include water, which is disregarded when stating the weights.

The water may originate from the residual moisture present in the lignocellulosic particles LCP-1) and/or LCP-2), from the binders B), C) and/or G), as for example if the isocyanate-containing binder is present in the form of an aqueous emulsion or if aqueous amino resins are used, from water additionally added, to dilute the binders or to moisten the outer layers, for example, from the additives E) and/or I), aqueous paraffin emulsions, for example, from the curing agents D) and/or H), aqueous ammonium salt solutions, for example, or from the expanded polymer particles A), if they are foamed using steam, for example. The water content of the individual layers can be up to 20 wt %, i.e., 0 to 20 wt %, preferably 2 to 15 wt %, more preferably 4 to 13 wt %, based on 100 wt % total dry weight. The water content in the outer layers DS-A and DS-C is preferably greater than in the core-B. Very preferably the water content of the outer layers DS-A and DS-C is 9 to 13 wt % and in the core-B is 4 to 8 wt %, based on 100 wt % total dry weight.

The pattern for the construction of the multilayer lignocellulosic materials is as follows:
(1) outer layer (DS-A), the upper outer layer,
(2) core (core-B), and
(3) outer layer (DS-C), the lower outer layer,
   it being possible for outer layers DS-A and DS-C to be constructed in each case from one or more, i.e., 1 to 5, preferably 1 to 3, more preferably 1 to 2 layers with different compositions, and with the compositions of outer layers DS-A and DS-C being identical or different, preferably identical. The structure of the multilayer lignocellulosic materials consists in particular of a core, an upper outer layer, and a lower outer layer.

The single-layer lignocellulosic materials consist only of one layer, corresponding to the core (core-B), and do not possess any outer layers DS-A and DS-C.

Further to the outer layers, the multilayer lignocellulosic material may comprise further external “protective layers”, preferably two further external layers, in other words an upper protective layer, which borders the outer layer DS-A (in the case of one layer) or borders the topmost of the upper outer layers DS-A (in the case of two or more layers), and a lower protective layer, which borders the outer layer DS-C (in the case of one layer) or the lowermost of the lower outer layers DS-C (in the case of two or more layers), these layers having any desired composition.

These protective layers are significantly thinner than the outer layers. The mass ratio between protective layers and outer layers is less than 10:90, preferably less than 5:95. Very preferably there are no protective layers present.

Further to the layer core-B, the single-layer woodbase material may comprise external protective layers, preferably two further external layers, i.e., an upper protective layer and a lower protective layer, which border layer core-B and which have any desired composition. These protective layers are significantly thinner than the layer core-B. The mass ratio between protective layers and core-B is less than 5:95, preferably less than 2:98. Very preferably there are no protective layers present.

The process of the invention can be implemented as follows:

Process Step i)—Mixing the Components of the Individual Layers In the case of single-layer lignocellulosic materials, the components LCP-1), A), B), C), D), E), and F) can be mixed in any order.

In the case of multilayer lignocellulosic materials, components LCP-1), A), B), C), D), E), and F) (composition of the core), and components LCP-2), G), H), I), and J) (composition of the outer layers) are mixed in separate mixing operations.

In the case of multilayer lignocellulosic materials, not only the components LCP-1), A), B), C), D), E), and F) of the core but also the components LCP-2), G), H), I), and J) of the outer layers can be mixed in any order.

Generally speaking, the lignocellulose particles [component LCP-1) in the case of single-layer and multilayer woodbase materials and component LCP-2) in the case of multilayer woodbase materials] are introduced first and components A), B), C), D), E), and F) in the case of single-layer and multilayer woodbase materials, and components G), H), I), and J) in the case of multilayer woodbase materials, are added in any order.

It is also possible to use mixtures of the individual components A), B), C), D), E), and F), in other words, for example, to mix components E) and F) before both components are together admixed to the lignocellulose particles LCP-1). In this case, components A), B), C), D), E), and F) can be divided into portions and these portions can be admixed individually or in a mixture with another component, at different times, to the lignocellulose particles LCP-1). If the component divided into portions consists of two or more different materials, the individual portions may have different compositions. These possibilities also exist analogously, in the case of multilayer woodbase materials, for components G), H), I), and J) in the outer layers.

In one preferred embodiment, only one mixture is produced for the outer layers, and this mixture for the two outer layers is divided in accordance with their weight ratio.

A further possibility is for components LCP-1) and, respectively LCP-2) to be composed of mixtures of different wood varieties and/or particle sizes. In one preferred embodiment, in the case of multilayer woodbase materials, the average particle sizes of component LCP-1) are greater than those of component LCP-2).

It is also possible for two or more components of the respective composition (composition of the outer layers and composition of the core or of the sole layer), as for example C) and D), or C) and a portion of D) or C), D), and E), or C), D), E), and F), to be mixed separately before being added. For example, component LCP-1) can be introduced initially, can be optionally mixed with component A), and subsequently a mixture of components B), C), D), E), and F), or a mixture of C), and D) followed by a mixture of B), E), and F), or a mixture of C) and D) followed by a mixture of B) and F), and followed by component E), can be added.

In one preferred embodiment, for the sole layer or for the layer of the core, component LCP-1) is admixed first with component A) and subsequently with components B), C), D), E), and F) in any order. It is also possible for two or more components to be mixed beforehand, preferably component D) with component C) and/or component F) with component C) and/or B).

In a further preferred embodiment, for the sole layer or for the layer of the core, component B) is mixed with the additive E) in a separate step, before being contacted with LCP-1) or with a mixture of LCP-1) with other components.

In a further preferred embodiment, for the sole layer or for the layer of the core, component B) is mixed with component F) in a separate step, before being contacted with LCP-1) or with a mixture of LCP-1) with other components.

In a further preferred embodiment, for the sole layer or for the layer of the core, component C) is mixed with the additive E) in a separate step, before being contacted with LCP-1) or with a mixture of LCP-1) with other components.

In a further preferred embodiment, for the sole layer or for the layer of the core, component C) is mixed with component F) or with component D), and with components F) or with component D), with component E) or with a portion of component E), and of components F) in a separate step, before being contacted with LCP-1) or with a mixture of LCP-1) with other components.

In a further preferred embodiment, for the sole layer or for the layer of the core, component C) is mixed with a portion of component F) or with component D) and a portion of components F) or with component D), with component E) and/or with a portion of component E) and a portion of components F), and component B) is mixed with a portion of component F) or with component E) and/or with a portion of component E) and with a portion of components F), in separate steps, before they are contacted with LCP-1) or with a mixture of LCP-1) with other components.

In a further preferred embodiment, for the sole layer or for the layer of the core, component C) is mixed with the curing agent D) in a separate step, before being contacted with LCP-1) or with a mixture of LCP-1) with other components.

In a further preferred embodiment, component C) is mixed with component D) and component E) in a separate step, before being contacted with LCP-1) or with a mixture of LCP-1) with other components.

Component B), optionally mixed in a separate step with one or more components selected from the groups of components D), E), and F), and component C), which has optionally been mixed in a separate step with one or more components selected from the groups of components D), E), and F), can be added either simultaneously or in succession, preferably simultaneously, to the lignocellulose particles LCP-1) or to the mixture of lignocellulose particles LCP-1) with other components. The simultaneous addition may be made, for example, by adding component B) or the mixture comprising component B), and component C) or the mixture comprising component C), from separate application devices, nozzles for example, at the same time, to the lignocellulose particles LCP-1) or to the mixture of lignocellulose particles LCP-1) with other components, or by supplying component B) or the mixture comprising component B), and component C) or the mixture comprising component C), from separate containers, to a mixing assembly, examples being mixing vessels or static mixers, and adding the resulting mixture after not more than 60 minutes, preferably after not more than 5 minutes, more preferably after not more than 60 seconds, very preferably after not more than 10 seconds, more particularly after not more than 2 seconds, to the lignocellulose particles LCP-1) or to the mixture of lignocellulose particles LCP-1) with other components.

The mixing of components A) to F) with component LCP-1) and/or G) to J) with component LCP-2) may take place according to the methods known in the woodbase material industry, as described in, for example, M. Dunky, P. Niemz, Holzwerkstoffe and Leime, pages 118 to 119 and page 145, Springer Verlag Heidelberg, 2002.

Mixing can be accomplished by spraying the components or mixtures of the components on to the lignocellulosic particles in devices such as high-speed annular mixers, with addition of resin via a hollow shaft (internal resination), or high-speed annular mixers with addition of resin from the outside via nozzles (external resination).

Where lignocellulose fibers are used as component LCP-1) and/or LCP-2), application by spraying may also take place in the blow line downstream of the refiner.

Where lignocellulose strips (strands) are used as component LCP-1) and/or LCP-2), sprayed application takes place in general in high-volume slow-speed mixers.

Mixing may also be accomplished by sprayed application in a falling shaft, as described in DE 10247412 A1 or DE 10104047 A1, for example, or by the spraying of a curtain composed of lignocellulose particles, in the manner realized in the Evojet technology from Dieffenbacher GmbH.

Process Step ii)—Scattering the Mixture(s) Produced in Process Step i) to Form a Mat

For the single-layer lignocellulosic material, the resulting mixture of LCP-1), A), B), C), D), E), and F) is scattered to form a mat.

For the multilayer lignocellulosic material, the resulting mixtures of components LCP-1), A), B), C), D), E), and F), and the mixtures of components LCP-2), G), H), I), and J) are scattered one over another to form a mat, producing the inventive construction of the multilayer lignocellulosic materials [in accordance with pattern (1), (2), (3)]. Scattering here is generally of the lower outer layers, beginning with the outermost outer layer through the lower outer layer closest to the core, after which comes the core layer, and after that the upper outer layers, beginning with the upper outer layer closest to the core and continuing to the outermost outer layer.

For this purpose, generally speaking, the mixtures are scattered directly onto an underlay, as for example onto a forming belt.

Scattering may be implemented using methods that are known per se, such as mechanical scattering or pneumatic scattering, or, for example, using roller systems (see, for example, M. Dunky, P. Niemz, Holzwerkstoffe and Leime, pages 119 to 121, Springer Verlag Heidelberg, 2002), discontinuously or continuously, preferably continuously.

Process Step iii)—Precompacting the Scattered Mat

The scattering of each individual layer may be followed by precompaction. In the case of the multilayer lignocellulosic materials, precompaction may take place in general after the scattering of each individual layer; preferably, precompaction is carried out after all of the layers have been scattered one over another.

Precompaction may take place by methods known to the skilled person, as are described in, for example, M. Dunky, P. Niemz, Holzwerkstoffe and Leime, Springer Verlag Heidelberg, 2002, page 819 or in H.-J. Deppe, K. Ernst, MDF—Mitteldichte Faserplatte, DRW-Verlag, 1996, pages 44, 45, and 93, or in A. Wagenführ, F. Scholz, Taschenbuch der Holztechnik, Fachbuchverlag Leipzig, 2012, page 219.

During or after the precompaction and before process step iv), it is possible for energy to be introduced into the mat with one or more arbitrary energy sources in a preheating step. Suitable energy sources include hot air, steam, steam/air mixtures, or electrical energy (high-frequency high-voltage field or microwaves). The mat in this case is heated in the core to 40 to 130° C., preferably to 50 to 100° C., more preferably to 55 to 75° C. The preheating with steam and steam/air mixtures in the case of multilayer lignocellulosic materials may also be carried out in such a way that only the outer layers are heated, but not the core. In the case of multilayer lignocellulosic materials as well, the core is preferably heated.

If there is preheating after the precompaction, expansion of the mat during heating can be prevented by carrying out heating within an upwardly and downwardly delimited space. The delimiting areas in this case are designed such that input of energy is possible. For example, perforated plastic belts or steel meshes can be used, which allow hot air, steam or steam/air mixtures to flow through them. The delimiting areas are optionally designed such that they exert a pressure on the mat of a sufficient degree to prevent expansion during heating.

With particular preference there is no preheating after the precompaction, meaning that the scattered mat after process step iii) has a lower temperature than or the same temperature as before process step iii).

Compaction may take place in one, two or more steps.

Precompaction takes place in general at a pressure of 1 to 30 bar, preferably 2 to 25 bar, more preferably 3 to 20 bar.

Process Step iv)—Pressing of the Precompacted Mat at Elevated Temperature

In process step iv) the thickness of the mat is reduced further by application of a pressing pressure. The temperature of the mat is raised by input of energy during this procedure. In the simplest case, a constant pressing pressure is applied and at the same time heating takes place by a constant-power energy source. Both the energy input and the compaction by pressing pressure, however, may also take place at different points in time and in a plurality of stages. The energy input in process step iv) takes place in general
a) by application of a high-frequency electrical field and/or
b) by hot pressing, in other words by transmission of heat from heated surfaces, examples being metal pressing platens, to the mat during the pressing operation,
   preferably b) by hot pressing.
a) Energy input by application of a high-frequency electrical field
   In the case of energy input by application of a high-frequency electrical field the mat is heated in such a way that after the high-frequency electrical field is shut off, in process step iv), the layer of the core has a temperature of more than 90° C. and this temperature is achieved in less than 40 seconds, preferably less than 20 seconds, more preferably less than 12.5 seconds, more particularly less than 7.5 seconds per mm plate thickness d starting from the application of the high-frequency electrical field, where d is the thickness of the plate after process step iv).
   When the high-frequency electrical field is shut off, the temperature in the core is at least 90° C., i.e., 90 to 170° C., preferably at least 100° C., i.e., 100 to 170° C., more preferably at least 110° C., i.e., 110 to 170° C., more particularly at least 120° C., i.e., 120 to 170° C.
   The high-frequency electrical field that is applied may constitute microwave radiation or may be a high-frequency electrical field which comes about following application of a high-frequency alternating current field to a plate capacitor between the two capacitor plates.
   In one particularly preferred embodiment, a compaction step can be carried out first, followed by the heating by application of a high-frequency high-voltage field. This operation may be carried out either continuously or discontinuously, preferably continuously.
   For this purpose, the scattered and compacted mat may be conveyed on a conveying belt through a region between parallel-arranged plate capacitors.
   Apparatus for a continuous operation, in order to realize heating by application of a high-frequency electrical field following compaction within the same machine, is described in WO-A-97/28936, for example.
   Heating immediately after the compaction step may also take place in a discontinuously operating high-frequency press, as for example in a high-frequency press, the HLOP 170 press from Hoefer Presstechnik GmbH being one example.
   If heating takes place after compaction, expansion of the mat during heating can be suppressed, minimized or prevented by carrying out the heating in an upwardly and downwardly delimited space. The design of the delimiting areas here is such as to permit energy input. The delimiting areas are optionally designed such that they exert a pressure on the mat that is sufficient to prevent expansion during heating.
   In one particular embodiment for a continuous process, these delimiting areas are pressing belts driven by rollers. Arranged behind these pressing belts are the plates of the capacitors. The mat is conducted through a pair of capacitor plates, with one pressing belt being disposed between mat and upper capacitor plate, and the other pressing belt between mat and lower capacitor plate. One of the two capacitor plates may be grounded, causing the high-frequency heating to operate according to the principle of asymmetrical feeding.
   With regard to the multilayer lignocellulosic materials, the outer layers DS-A and DS-C may have a different temperature from the core-B after process step iv). In general the temperature difference amounts to between 0 and 50° C.
b) Energy input by hot pressing
   Energy input by hot pressing is accomplished typically by contact with heated pressing surfaces that have temperatures of 80 to 300° C., preferably 120 to 280° C., more preferably 150 to 250° C., with pressing during energy input taking place at a pressure of 1 to 50 bar, preferably 3 to 40 bar, more preferably 5 to 30 bar. Pressing may be accomplished by any of the methods known to the skilled person (see examples in “Taschenbuch der Spanplatten Technik”, H.-J. Deppe, K. Ernst, 4th edn., 2000, DRW—Verlag Weinbrenner, Leinfelden Echterdingen, pages 232 to 254, and “MDF—Mitteldichte Faserplatten” H.-J. Deppe, K. Ernst, 1996, DRW—Verlag Weinbrenner, Leinfelden-Echterdingen, pages 93 to 104). Preference is given to using continuous pressing techniques, using double belt presses, for example. The duration of pressing is normally 2 to 15 seconds per mm plate thickness, preferably 2 to 10 seconds, more preferably 2 to 6 seconds, more particularly 2 to 4 seconds, they may also be significantly different from this and they may even last for up to several minutes, e.g., up to 5 minutes.
   Where energy input in process step iv) takes place by a) application of a high-frequency electrical field and by b) hot pressing, it is preferred to carry out step a) first and step b) thereafter.

The meanings of the components of the core LPC-1), A), B), C), D), E), F), and the components of the outer layers LPC-2), G), H), I), and J) are as follows.

Component LPC-1) and LPC-2)

Suitable raw material for the lignocellulose particles LPC-1) and LPC-2) is any desired wood species or mixtures thereof, examples being spruce, beech, pine, larch, lime, poplar, eucalyptus, ash, chestnut, or fir wood or mixtures thereof, preferably spruce, beech or mixtures thereof, especially spruce. The lignocellulose particles LPC-1) and LPC-2) may be, for example, pieces of wood such as wood layers, wood strips (strands), wood chips, wood fibers, wood dust, or mixtures thereof, preferably wood chips, wood fibers, wood strips (strands) and mixtures thereof, more preferably wood chips, wood fibers or mixtures thereof, as are used for the production of particle board, MDF (medium-density fiber board), and HDF (high-density fiber board). The lignocellulose particles may also come from lignocellulose-containing plants such as bamboo, flax, hemp, cereals or other annual plants, preferably from bamboo, flax or hemp. Particularly preferred for use are wood chips of the kind used in the production of particle board.

Starting materials for the lignocellulose particles are customarily roundwoods, lumber from forestry thinning, residual lumber, waste forest lumber, residual industrial lumber, used lumber, production wastes from the production of woodbase materials, used woodbase materials, and lignocellulosic plants. Processing to the desired lignocellulosic particles, as for example to wood particles such as wood chips or wood fibers, may take place in accordance with methods that are known per se (e.g., M. Dunky, P. Niemz, Holzwerkstoffe and Leime, pages 91 to 156, Springer Verlag Heidelberg, 2002).

The size of lignocellulose particles may be varied within wide limits and may fluctuate within wide limits.

When the lignocellulose particles LPC-1) and LPC-2) are lignocellulose fibers, the volume-weighted average fiber length of component LPC-2) of the outer layers is preferably less than or equal to the volume-weighted average fiber length of component LPC-1) in the core of the multilayer lignocellulosic materials. The ratio of the volume-weighted average fiber lengths (x̅ₑₓₜₑₙₜ) of component LPC-2) to the volume-weighted average fiber lengths (x̅ₑₓₜₑₙₜ) of component LPC-1) may be varied within wide limits and is generally 0.1:1 to 1:1, preferably 0.5:1 to 1:1, more preferably 0.8:1 to 1:1.

The volume-weighted average fiber length (x̅ₑₓₜₑₙₜ) of component LPC-1) is generally 0.1 to 20 mm, preferably 0.2 to 10 mm, more preferably 0.3 to 8 mm, very preferably 0.4 to 6 mm.

The volume-weighted average fiber length (x̅ₑₓₜₑₙₜ) is determined by digital image analysis. Use may be made, for example, of an instrument from the Camsizer® series from Retsch Technology. In this case, a representative sample xₑₓₜₑₙₜ is determined for each individual fiber. xₑₓₜₑₙₜ is calculated from the area of the particle projection A and the Martin diameter x_{Ma}_{_}ₘᵢₙ. The relationship here is that xₑₓₜₑₙₜ=x_{Ma}_{_}ₘᵢₙ/A. From the individual values, the volume-weighted average x̅ₑₓₜₑₙₜ is formed. The measurement method and evaluation are described in the Camsizer handbook (operating instructions/handbook for particle size measuring system CAMSIZER®, Retsch Technology GmbH, Version 0445.506, Release 002, Revision 009 of Jun. 25, 2010).

If the lignocellulose particles LPC-1) and LPC-2) are lignocellulose strips (strands), or lignocellulose chips, the volume-weighted average particle diameter of component LPC-2) of the outer layers is preferably less than or equal to the volume-weighted average particle diameter of component LPC-1) in the core of the multilayer lignocellulose materials. The ratio of the volume-weighted average particle diameter x̅_{Fe max} of component LPC-2) to the volume-weighted average particle diameter x̅_{Fe max} of component LPC-1) can be varied within wide limits and is generally 0.01:1 to 1:1, preferably 0.1:1 to 0.95:1, more preferably 0.5:1 to 0.9:1.

The volume-weighted average particle diameter x̅_{Fe max} of component LPC-1) is generally 0.5 to 100 mm, preferably 1 to 50 mm, more preferably 2 to 30 mm, very preferably 3 to 20 mm.

The volume-weighted average particle diameter x̅_{Fe max} is determined by digital image analysis. Use may be made, for example, of an instrument from the Camsizer® series from Retsch Technology. In this case, a representative sample x_{Fe max} is determined for each individual lignocellulose strip (strand) or each single lignocellulose chip. x_{Fe max} is the greatest Feret diameter of a particle (determined from different measurement directions). From the individual values, the volume-weighted average x̅_{Fe max} is formed. The measurement method and evaluation are described in the Camsizer handbook (operating instructions/handbook for particle size measuring system CAMSIZER®, Retsch Technology GmbH, Version 0445.506, Release 002, Revision 009 of Jun. 25, 2010).

Where mixtures of wood chips and other lignocellulose particles are used, such as mixtures of wood chips and wood fibers, or of wood chips and wood dust, for example, the fraction of wood chips in component LPC-1) and/or in component LPC-2) is generally at least 50 wt %, i.e., 50 to 100 wt %, preferably at least 75 wt %, i.e., 75 to 100 wt %, more preferably at least 90 wt %, i.e., 90 to 100 wt %.

The average densities of components LPC-1) and LPC-2) are situated, independently of one another, in general at 0.4 to 0.85 g/cm³, preferably at 0.4 to 0.75 g/cm³, more particularly at 0.4 to 0.6 g/cm³. These figures relate to the standard apparent density after storage under standard conditions (20° C., 65% humidity).

Independently of one another, components LPC-1) and LPC-2) may comprise the customary small quantities of water at 0 to 10 wt %, preferably 0.5 to 8 wt %, more preferably 1 to 5 wt % (within a customary small fluctuation range of 0 to 0.5 wt %, preferably 0 to 0.4 wt %, more preferably 0 to 0.3 wt %). This quantity figure relates to 100 wt % of absolutely dry wood material, and describes the water content of component LPC-1) and/or LPC-2) after drying (by customary methods known to the skilled person) immediately prior to mixing with other components.

In a further preferred embodiment, lignocellulose fibers are used as lignocellulose particles LPC-2) for the outer layers and lignocellulose strips (strands) or lignocellulose chips, more preferably lignocellulose chips, especially lignocellulose chips having a volume-weighted average particle diameter x̅_{Fe max} of 2 to 30 mm, are used as lignocellulose particles LPC-1) for the core.

Component A)

Suitable expanded plastics particles of component A) are expanded plastics particles, preferably expanded thermoplastic polymer particles having a bulk density of 10 to 150 kg/m³, preferably 30 to 130 kg/m³, more preferably 35 to 110 kg/m³, especially 40 to 100 kg/m³ (determined by weighing a defined volume filled with the bulk material).

Expanded plastics particles of component A) are used generally in the form of spheres or beads having an average diameter of 0.01 to 50 mm, preferably 0.25 to 10 mm, more preferably 0.4 to 8.5 mm, especially 0.4 to 7 mm. In one preferred embodiment, the spheres have a small surface area per unit volume, in the form, for example, of a spherical or elliptical particle, and are preferably of closed-cell form. The open-cell content according to DIN ISO 4590 is generally not more than 30%, i.e., 0 to 30%, preferably 1 to 25%, more preferably 5 to 15%.

Suitable polymers forming the basis of the expandable or expanded plastics particles are generally all known polymers or mixtures thereof, preferably thermoplastic polymers or mixtures thereof, which can be foamed. Examples of highly suitable such polymers include polyketones, polysulfones, polyoxymethylene, PVC (rigid and flexible), polycarbonates, polyisocyanurates, polycarbodiimides, polyacrylimides and polymethacrylimides, polyamides, polyurethanes, aminoresins and phenolic resins, styrene homopolymers (also referred to hereinafter as “polystyrene” or “styrene polymer”), styrene copolymers, C₂ to C₁₀ olefin homopolymers, C₂ to C₁₀ olefin copolymers, and polyesters. For producing the stated olefin polymers, preference is given to using the 1-alkenes, as for example ethylene, propylene, 1-butene, 1-hexene, 1-octene.

Furthermore, the polymers, preferably the thermoplastics, which form the basis for the expandable or expanded plastics particles of component A) may have been admixed with customary additives, examples being UV stabilizers, antioxidants, coating agents, hydrophobizing agents, nucleating agents, plasticizers, flame retardants, and soluble and insoluble organic and/or inorganic colorants.

Component A may customarily be obtained as follows.

Suitable polymers may be expanded using an expansible medium (also called “blowing agent”) or comprising an expansible medium, by exposure to microwave energy, thermal energy, hot air, preferably steam, and/or pressure change (this expansion often also being referred to as “foaming”) (Kunststoff Handbuch 1996, volume 4 “Polystyrol”, Hanser 1996, pages 640 to 673 or U.S. Pat. No. 5,112,875). In this operation, generally speaking, the blowing agent expands, the particles increase in size, and cell structures are formed. This expansion may be carried out in customary foaming apparatus, often termed “prefoamers”. Such prefoamers may be fixed installations or else may be mobile. Expanding can be done in one or more stages. In the case of the one-stage process, generally, the expandable plastics particles are simply expanded to the desired final size. In the case of the multistage process, in general, the expandable plastics particles are first expanded to an intermediate size, and then expanded in one or more further stages, via a corresponding number of intermediate sizes, to the desired final size. The compact plastics particles stated above, also called “expandable plastics particles” herein, differ from the expanded plastics particles in general having no cell structures. The expanded plastics particles generally still have a low blowing agent content of 0 to 5 wt %, preferably 0.5 to 4 wt %, more preferably 1 to 3 wt %, based on the overall mass of plastic and blowing agent. The expanded plastic particles thus obtained may be stored temporarily or used further, without additional intermediate steps, for the production of component A of the invention.

To expand the expandable plastics particles it is possible to use all blowing agents known to the skilled person, examples being aliphatic C₃ to C₁₀ hydrocarbons, such as propane, n-butane, isobutane, n-pentane, isopentane, neopentane, cyclopentane and/or hexane and its isomers, alcohols, ketones, esters, ethers, or halogenated hydrocarbons, preferably n-pentane, isopentane, neopentane and cyclopentane, more preferably a commercial pentane isomer mixture composed of n-pentane and isopentane.

The amount of blowing agent in the expandable plastics particles is generally in the range from 0.01 to 7 wt %, preferably 0.6 to 5 wt %, more preferably 1.1 to 4 wt %, based in each case on the expandable plastics particles containing blowing agent.

One preferred embodiment uses styrene homopolymer (also referred to herein simply as “polystyrene”), styrene copolymer or mixtures thereof as the sole plastic in component A).

Such polystyrene and/or styrene copolymer may be produced by any of the polymerization processes known to the skilled person; see, for example, Ullmann's Encyclopedia, Sixth Edition, 2000 Electronic Release or Kunststoff-Handbuch 1996, volume 4 “Polystyrol”, pages 567 to 598.

The expanded polystyrene and/or styrene copolymer is produced in general in a manner known per se, by suspension polymerization or by means of extrusion processes.

In the case of the suspension polymerization, styrene, optionally with addition of further comonomers, can be polymerized in aqueous suspension in the presence of a customary suspension stabilizer using radical-forming catalysts. The blowing agent and any further customary adjuvants may be included in the initial polymerization charge, or added to the batch in the course of the polymerization or when polymerization is at an end. The beadlike, expandable styrene polymers that are obtained, impregnated with blowing agent, may be separated from the aqueous phase when polymerization is at an end, and washed, dried, and screened.

In the case of the extrusion process, the blowing agent can be mixed into the polymer via an extruder, for example, conveyed through a die plate, and pelletized under pressure to form particles or strands.

The expandable styrene polymers or expandable styrene copolymers which are preferred or particularly preferred, as described above, have a relatively low blowing agent content. Polymers of this kind are also referred to as “of low blowing agent content”. One highly suitable process for producing expandable polystyrene or expandable styrene copolymer of low blowing agent content is described in U.S. Pat. No. 5,112,875, incorporated herein expressly by reference.

As described, it is also possible to use styrene copolymers. Advantageously these styrene copolymers contain at least 50 wt %, i.e., 50 to 100 wt %, preferably at least 80 wt %, i.e., 80 to 100 wt %, of copolymerized styrene, based on the mass of the plastic (without blowing agent). Examples of comonomers contemplated include α-methylstyrene, ring-halogenated styrenes, acrylonitrile, esters of acrylic or methacrylic acid with alcohols having 1 to 8 C atoms, N-vinylcarbazole, maleic acid (or its anhydride), (meth)acrylamides and/or vinyl acetate.

The polystyrene and/or styrene copolymer may advantageously include a small amount of a copolymerized chain-branching agent, this being a compound having more than one, preferably two double bonds, such as divinylbenzene, butadiene and/or butanediol diacrylate. The branching agent is used generally in amounts of 0.0005 to 0.5 mol %, based on styrene. Mixtures of different styrene (co)polymers may also be used. Highly suitable styrene homopolymers or styrene copolymers are glass-clear polystyrene (GPPS), high-impact polystyrene (HIPS), anionically polymerized polystyrene or high-impact polystyrene (A-IPS), styrene-α-methylstyrene copolymers, acrylonitrile-butadiene-styrene polymers (ABS), styrene-acrylonitrile (SAN), acrylonitrile-styrene-acrylic ester (ASA), methyl acrylate-butadiene-styrene (MBS), methyl methacrylate-acrylonitrile-butadiene-styrene (MABS) polymers, or mixtures thereof, or used with polyphenylene ether (PPE).

Preference is given to using plastics particles, more preferably styrene polymers or styrene copolymers, especially styrene homopolymers, having a molecular weight in the range from 70 000 to 400 000 g/mol, more preferably 190 000 to 400 000 g/mol, very preferably 210 000 to 400 000 g/mol.

These expanded polystyrene particles or expanded styrene comonomer particles can be further used with or without additional measures for reducing blowing agent, for the production of the lignocellulosic substance.

The expandable polystyrene or expandable styrene copolymer or the expanded polystyrene or expanded styrene copolymer normally has an antistatic coating.

The polymer from which the expanded plastics particles (component A) are produced may be admixed before or during foaming of pigments and particles, such as carbon black, graphite or aluminum powders, as adjuvants.

The expanded plastics particles of component A) are generally in unmelted state even after the pressing operation to give the lignocellulosic material, meaning that in general the plastics particles of component A) have not penetrated or impregnated the lignocellulose particles, but are instead distributed between the lignocellulose particles. The plastics particles of component A) can customarily be separated from the lignocellulose by physical methods, as for example after the comminution of the lignocellulosic material.

The total amount of the expanded plastics particles of component A), based on the total dry mass of the core, is generally in the range from 0 to 25 wt %, preferably 0 to 20 wt %, more preferably 0 to 10 wt %, more particularly 0 wt %.

Components B), C) and G):

The total amount (dry mass) of the binder of component B), based on the total dry mass of the lignocellulose particles LCP-1), is in the range from 0.05 to 1.39 wt %, preferably 0.1 to 1 wt %, more preferably 0.15 to 0.8 wt %, very preferably 0.2 to 0.6 wt %

The total amount (dry mass) of the binder of component C), based on the total dry mass of the lignocellulose particles LCP-1), is in the range from 3 to 20 wt %. If the lignocellulose particles LCP-1) that are used consist essentially (to an extent of more than 75%) of lignocellulose fibers, then the total amount (dry mass) of the binder of component C), based on the total dry mass of the lignocellulose particles LCP-1), is preferably in the range from 7 to 15 wt %, more preferably 9 to 13 wt %. In all other cases (where the fraction of lignocellulose fibers is smaller and if no lignocellulose fibers are used), the total amount (dry mass) of the binder of component C), based on the total dry mass of the lignocellulose particles LCP-1), is preferably in the range from 5 to 13 wt %, more preferably 7 to 11 wt %.

The total amount (dry mass) of the binder of component G), based on the total dry mass of the lignocellulose particles LCP-2), is in the range from 1 to 30 wt %, preferably 2 to 20 wt %, more preferably 3 to 15 wt %.

Suitable binders of component B) are those selected from the group of organic isocyanates having at least two isocyanate groups or mixtures thereof.

Suitable binders of component C) are those selected from the group of the amino resins or mixtures thereof.

Suitable binders of component G) are those selected from the group of amino resins, phenolic resins, organic isocyanates having at least two isocyanate groups, protein-based binders, and other polymer-based binders. The weight figures, in the case of amino resins, phenolic resins, protein-based binders, and the other polymer-based binders, are based on the solids content of the component in question (determined by evaporating the water at 120° C. over the course of 2 hours in accordance with Gunter Zeppenfeld, Dirk Grunwald, Klebstoffe in der Holz- and Möbelindustrie, 2nd edition, DRW-Verlag, page 268), and, in relation to the isocyanate, especially PMDI (polymeric diphenylmethane diisocyanate), to the isocyanate component per se, in other words, for example, without solvent or without water as emulsifying medium.

Phenolic Resin

Phenolic resins are synthetic resins which are obtained by condensation of phenols with aldehydes and may optionally be modified. Besides unsubstituted phenol, derivatives of phenol as well may be used for preparing phenolic resins. These derivatives may be cresols, xylenols or other alkylphenols, as for example p-tert-butylphenol, p-tert-octylphenol, and p-tert-nonylphenol, arylphenols, as for example phenylphenol and naphthols, or divalent phenols, as for example resorcinol and bisphenol A. The most important aldehyde for the production of phenolic resins is formaldehyde, which can be used in various forms—for example, as an aqueous solution, or in solid form as para-formaldehyde, or as a formaldehyde donor substance. Other aldehydes, as for example acetaldehyde, acrolein, benzaldehyde, or furfural, and ketones, may also be used. Phenolic resins may be modified by chemical reactions of the methylol groups or of the phenolic hydroxyl groups and/or by physical dispersion in a modifying agent.

Preferred phenolic resins are phenol-aldehyde resins, more preferably phenol-formaldehyde resins (also called “PF resins”). They are known, for example, from Kunststoff-Handbuch, 2nd edition, Hanser 1988, volume 10 “Duroplaste”, pages 12 to 40.

Amino Resin

As amino resin it is possible to use all amino resins that are known to the skilled person, preferably those known for the production of wood based materials. Resins of these kinds and their preparation are described in, for example, Ullmanns Enzyklopädie der technischen Chemie, 4th, revised and expanded edition, Verlag Chemie, 1973, pages 403 to 424, “Aminoplaste”, and Ullmann's Encyclopedia of Industrial Chemistry, vol. A2, VCH Verlagsgesellschaft, 1985, pages 115 to 141 “Amino Resins”, and also in M. Dunky, P. Niemz, Holzwerkstoffe and Leime, Springer 2002, pages 251 to 259 (UF resins) and pages 303 to 313 (MUF and UF with a small amount of melamine). Generally they are polycondensation products of compounds having at least one amino group, optionally substituted in part with organic radicals, or at least one carbamide group (the carbamide group is also called carboxamide group), preferably carbamide group, preferably urea or melamine, and an aldehyde, preferably formaldehyde. Preferred polycondensation products are urea-formaldehyde resins (UF resins), melamine-formaldehyde resins (MF resins), or melamine-containing urea-formaldehyde resins (MUF resins), more preferably urea-formaldehyde resins, examples being Kaurit® glue products from BASF SE.

Particularly preferred polycondensation products are those wherein the molar ratio of aldehyde to the optionally partly organic-radical-substituted amino group and/or carbamide group is in the range from 0.3:1 to 1:1, preferably 0.3:1 to 0.6:1, more preferably 0.3:1 to 0.5:1, very preferably 0.3:1 to 0.45:1.

The stated amino resins are customarily used in liquid form, customarily as a suspension or solution with a concentration or strength of 25 to 90 wt %, preferably 50 to 70 wt %, preferably in aqueous solution or suspension, but may alternatively be used as solids.

Organic Isocyanates

Organic isocyanates that are suitable include organic isocyanates of at least two isocyanate groups or mixtures thereof, particularly all of the organic isocyanates or mixtures thereof that are known to the skilled person, preferably those known for the production of wood base materials or polyurethanes. Organic isocyanates of these kinds and also their preparation and use are described in, for example, Becker/Braun, Kunststoff Handbuch, 3^{rd} revised edition, volume 7, “Polyurethane”, Hanser 1993, pages 17 to 21, pages 76 to 88 and pages 665 to 671.

Preferred organic isocyanates are oligomeric isocyanates having from 2 to 10, preferably from 2 to 8, monomer units and on average at least one isocyanate group per monomer unit, or a mixture of these. The isocyanates can be aliphatic, cycloaliphatic, or aromatic. Particular preference is given to the organic isocyanate MDI (methylenediphenyl diisocyanate), the oligomeric organic isocyanate PMDI (polymeric methylenediphenylene diisocyanate), these being obtainable via condensation of formaldehyde with aniline and phosgenation of the isomers and oligomers produced in the condensation reaction (see by way of example Becker/Braun, Kunststoff Handbuch, 3rd revised edition, volume 7 “Polyurethane”, Hanser 1993, p. 18 final paragraph to p. 19, second paragraph, and p. 76, fifth paragraph), or a mixture of MDI and PMDI. Very particular preference is given to products from the LUPRANAT® line from BASF SE, in particular LUPRANAT® M 20 FB from BASF SE.

The organic isocyanate can also be an isocyanate-terminated prepolymer which is the reaction product of an isocyanate, e.g. PMDI, with one or more polyols and/or polyamines.

Polyols selected from the group of ethylene glycol, diethylene glycol, propylene glycol, dipropylene glycol, butanediol, glycerol, trimethylolpropane, triethanolamine, pentaerythritol, sorbitol, and mixtures thereof can be used. Other suitable polyols are biopolyols, such as polyols derived from soya oil, rapeseed oil, castor oil, and sunflower oil. Other suitable materials are polyether polyols which can be obtained via polymerization of cyclic oxides, for example ethylene oxide, propylene oxide, butylene oxide, or tetrahydrofuran in the presence of polyfunctional initiators. Suitable initiators comprise active hydrogen atoms, and can be water, butanediol, ethylene glycol, propylene glycol, diethylene glycol, triethylene glycol, dipropylene glycol, ethanolamine, diethanolamine, triethanolamine, toluenediamine, diethyltoluenediamine, phenyldiamine, diphenylmethanediamine, ethylenediamine, cyclohexanediamine, cylcohexanedimethanol, resorcinol, bisphenol A, glycerol, trimethylolpropane, 1,2,6-hexanetriol, pentaerythritol, or any mixture thereof. Other suitable polyether polyols comprise diols and trials such as polyoxypropylenediols and -triols, and poly(oxyethylene-oxypropylene)diols and -triols, these being produced via simultaneous or successive addition reactions of ethylene oxides and propylene oxides with di- or trifunctional initiators. Other suitable materials are polyester polyols such as hydroxy-terminated reaction products of polyols as described above with polycarboxylic acids or polycarboxylic acid derivatives, e.g. anhydrides thereof, in particular dicarboxylic acids or dicarboxylic acid derivatives, for example succinic acid, dimethyl succinate, glutaric acid, dimethyl glutarate, adipic acid, dimethyl adipate, sebacic acid, phthalic anhydride, tetrachlorophthalic anhydride, or dimethyl terephthalate, or a mixture thereof.

Polyamines selected from the group of ethylenediamine, toluenediamine, diaminodiphenylmethane, polymethylene polyphenyl polyamines, amino alcohols, and mixtures thereof can be used. Examples of amino alcohols are ethanolamine and diethanolamine.

The organic isocyanate or the isocyanate-terminated prepolymer can also be used in the form of an aqueous emulsion which is produced by way of example via mixing with water in the presence of an emulsifier. The organic isocyanate or the isocyanate component of the prepolymer can also be modified isocyanates, such as carbodiimides, allophanates, isocyanurates, and biurets.

Protein-Based Binders

Examples of suitable protein-based binders are casein glues, animal glues, and blood albumin glues. It is also possible to use binders where alkaline-hydrolyzed proteins are used as binder constituent. Binders of this type are described in M. Dunky, P. Niemz, Holzwerkstoffe and Leime, Springer 2002, pp. 415 to 417.

Soya-protein-based binders are particularly suitable. These binders are typically produced from soya flour. The soya flour can optionally be modified. The soya-based binder can take the form of dispersion. It comprises various functional groups, for example lysine, histidine, arginine, tyrosine, tryptophan, serine and/or cysteine. In one particular embodiment the soya protein is copolymerized, e.g., with phenolic resin, urea resin, or PMDI. In one very particular embodiment the soya-based binder is composed of a combination of a polyamidoepichlorohydrin resin (PAE) with a soya-based binder. An example of a suitable binder is the commercially obtainable binder system Hercules° PTV D-41080 Resin (PAE resin) and PTV D-40999 (soya component).

Other Polymer-Based Binders

Suitable polymer-based binders are aqueous binders which comprise a polymer N composed of the following monomers:
a) from 70 to 100% by weight of at least one ethylenically unsaturated mono- and/or dicarboxylic acid (monomer(s) N₁) and
b) from 0 to 30% by weight of at least one other ethylenically unsaturated monomer which differs from the monomers N₁ (monomer(s) N₂), and optionally a low-molecular-weight crosslinking agent having at least two functional groups selected from the group of hydroxy, carboxylic acid and derivatives thereof, primary, secondary, and tertiary amine, epoxy, and aldehyde.

The production of polymers N is familiar to the person skilled in the art and in particular is achieved via radical-initiated solution polymerization for example in water or in an organic solvent (see by way of example A. Echte, Handbuch der Technischen Polymerchemie, chapter 6, VCH, Weinheim, 1993 or B. Vollmert, Grundriss der Makromolekularen Chemie, vol. 1, E. Vollmert Verlag, Karlsruhe, 1988).

Particular monomers N1 that can be used are α,β-monoethylenically unsaturated mono- and dicarboxylic acids having from 3 to 6 C atoms, possible anhydrides of these, and also water-soluble salts of these, in particular alkali metal salts of these, examples being acrylic acid, methacrylic acid, maleic acid, fumaric acid, itaconic acid, citraconic acid, tetrahydrophthalic acid, and anhydrides of these, for example maleic anhydride, and also the sodium or potassium salts of the abovementioned acids. Particular preference is given to acrylic acid, methacrylic acid, and/or maleic anhydride, and in particular preference is given here to acrylic acid and to the double combinations of acrylic acid and maleic anhydride, or of acrylic acid and maleic acid.

Monomer(s) N₂ that can be used are ethylenically unsaturated compounds that are easily copolymerizable by a radical route with monomer(s) N₁, for example ethylene, C₃- to C₂₄-α-olefins, such as propene, 1-hexene, 1-octene, 1-decene; vinylaromatic monomers, such as styrene, α-methylstyrene, o-chlorostyrene, or vinyltoluenes; vinyl halides, such as vinyl chloride or vinylidene chloride; esters derived from vinyl alcohol and from monocarboxylic acids having from 1 to 18 C atoms, for example vinyl acetate, vinyl propionate, vinyl n-butyrate, vinyl laurate, and vinyl stearate; esters derived from α,β-monoethylenically unsaturated mono- and dicarboxylic acids having preferably from 3 to 6 C atoms, particular examples being acrylic acid, methacrylic acid, maleic acid, fumaric acid, and itaconic acid, with alkanols generally having from 1 to 12, preferably from 1 to 8, and in particular from 1 to 4, C atoms, particular examples being the methyl, ethyl, n-butyl, isobutyl, pentyl, hexyl, heptyl, octyl, nonyl, decyl, and 2-ethylhexyl esters of acrylic acid and of methacrylic acid, the dimethyl or di-n-butyl esters of fumaric and of maleic acid; nitriles of α,β-monoethylenically unsaturated carboxylic acids, for example acrylonitrile, methacrylonitrile, fumaronitrile, maleonitrile, and also C₄- to C₈-conjugated dienes, such as 1,3-butadiene and isoprene. The monomers mentioned generally form the main monomers, and these combine to form a proportion of >50% by weight, preferably >80% by weight, and particularly preferably >90% by weight, based on the entirety of the monomers N₂, or indeed form the entirety of the monomers N₂. The solubility of these monomers in water under standard conditions (20° C., 1 atm (absolute)) is very generally only moderate to low.

Other monomers N₂, which however have higher water-solubility under the abovementioned conditions, are those comprising at least one sulfonic acid group and/or anion corresponding thereto or at least one amino, amido, ureido, or N-heterocyclic group, and/or nitrogen-protonated or -alkylated ammonium derivatives thereof. Mention may be made of acrylamide and methacrylamide by way of example; and also of vinylsulfonic acid, 2-acrylamido-2-methylpropanesulfonic acid, styrenesulfonic acid, and water-soluble salts thereof, and also N-vinylpyrrolidone; 2-vinylpyridine, 4-vinylpyridine; 2-vinylimidazole; 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate.

The abovementioned water-soluble monomers N₂ are usually comprised merely as modifying monomers in quantities of <10% by weight, preferably <5% by weight, and particularly preferably <3% by weight, based on the entirety of monomers N₂.

Further monomers N₂, where these usually increase the internal strength of the filmed polymer matrix, normally have at least one epoxy, hydroxy, N-methylol, or carbonyl group, or at least two non-conjugated ethylenically unsaturated double bonds. Examples hereof are monomers having two vinyl moieties, monomers having two vinylidene moieties, and also monomers having two alkenyl moieties. Particularly advantageous monomers here are the diesters of dihydric alcohols with α,β-monoethylenically unsaturated monocarboxylic acids, and among these preference is given to acrylic acid and methacrylic acid. Examples of monomers of this type having two non-conjugated ethylenically unsaturated double bonds are alkylene glycol diacrylates and alkylene glycol dimethacrylates, for example ethylene glycol diacrylate, propylene 1,2-glycol diacrylate, propylene 1,3-glycol diacrylate, butylene 1,3-glycol diacrylate, butylene 1,4-glycol diacrylates and ethylene glycol dimethacrylate, propylene 1,2-glycol dimethacrylate, propylene 1,3-glycol dimethacrylate, butylene glycol 1,3-dimethacrylate, butylene glycol 1,4-dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. Other materials of particular importance in this context are the C₁- to C₈-hydroxyalkyl esters of methacrylic and of acrylic acid, for example n-hydroxyethyl, n-hydroxypropyl, or n-hydroxybutyl acrylate and the corresponding methacrylates, and also compounds such as diacetoneacrylamide and acetylacetoxyethyl acrylate and the corresponding methacrylate.

Quantities used of the abovementioned crosslinking monomers N₂ are frequently <10% by weight, but preferably <5% by weight, based in each case on the entirety of monomers N₂. However, it is particularly preferable not to use any of these crosslinking monomers N₂ to produce the polymer N.

Preferred polymers N are obtainable via radical-initiated solution polymerization only of monomers N₁, particularly preferably of from 65 to 100% by weight, very particularly preferably from 70 to 90% by weight, of acrylic acid with particularly preferably from 0 to 35% by weight, very particularly preferably from 10 to 30% by weight, of maleic acid or maleic anhydride.

The weight-average molar mass M_{w} of polymer N is advantageously from 1000 to 500 000 g/mol, preferably from 10 000 to 300 000 g/mol, particularly preferably from 30 000 to 120 000 g/mol.

Adjustment of the weight-average molar mass M_{w} during the production of polymer N is familiar to the person skilled in the art, and is advantageously achieved via radical-initiated aqueous solution polymerization in the presence of compounds that provide radical-chain transfer, known as radical-chain transfer agents. Determination of the weight-average molar mass M_{w} is also familiar to the person skilled in the art, and is achieved by way of example by means of gel permeation chromatography.

Commercially available products with good suitability for polymers N are by way of example the Sokalan® products from BASF SE, which are by way of example based on acrylic acid and/or maleic acid. WO-A-99/02591 describes other suitable polymers.

Crosslinking agents with good suitability are those with a (weight-average) molar mass in the range from 30 to 10 000 g/mol. The following may be mentioned by way of example: alkanolamines, such as triethanolamine; carboxylic acids, such as citric acid, tartaric acid, butanetetracarboxylic acid; alcohols, such as glucose, sucrose, or other sugars, glycerol, glycol, sorbitol, trimethylolpropane; epoxides, such as bisphenol A or bisphenol F, and also resins based thereon and moreover polyalkylene oxide glycidyl ethers or trimethylolpropane triglycidyl ether. In one preferred embodiment of the invention the molar mass of the low-molecular-weight crosslinking agent used is in the range from 30 to 4000 g/mol, particularly preferably in the range from 30 to 500 g/mol.

Other suitable polymer-based binders are aqueous dispersions which comprise one or more polymers composed of the following monomers:
a. from 0 to 50% by weight of at least one ethylenically unsaturated monomer which comprises at least one epoxy group and/or at least one hydroxyalkyl group (monomer(s) M₁), and
b. from 50 to 100% by weight of at least one other ethylenically unsaturated monomer which differs from the monomers M₁ (monomer(s) M₂).

Polymer M is obtainable via radical-initiated emulsion polymerization of the appropriate monomers M₁ and/or M₂ in an aqueous medium. Polymer M can have one or more phases. Polymer M can have a core-shell structure.

The conduct of radical-initiated emulsion polymerization reactions of ethylenically unsaturated monomers in an aqueous medium has been widely described and is therefore well known to the person skilled in the art (see by way of example: Emulsion Polymerisation in Encyclopedia of Polymer Science and Engineering, vol. 8, pp. 659 ff. (1987); D. C. Blackley, in High Polymer Latices, vol. 1, pp. 35 ff. (1966); H. Warson, The Applications of Synthetic Resin Emulsions, chapter 5, pp. 246 ff. (1972); D. Diederich, Chemie in unserer Zeit 24, pp. 135 to 142 (1990); Emulsion Polymerisation, Interscience Publishers, New York (1965); DE-A 40 03 422, and Dispersionen Synthetischer Hochpolymerer, F. Hölscher, Springer-Verlag, Berlin (1969)).

The procedure for the radical-initiated aqueous emulsion polymerization reactions is usually that the ethylenically unsaturated monomers are dispersed in the form of monomer droplets in the aqueous medium with concomitant use of dispersing agents, and are polymerized by means of a radical polymerization initiator.

Monomer(s) M₁ that can be used are in particular glycidyl acrylate and/or glycidyl methacrylate, and also hydroxyalkyl acrylates and the corresponding methacrylates, in both cases having C₂- to C₁₀-hydroxyalkyl groups, in particular C₂- to C4-hydroxyalkyl groups, and preferably C₂- and C₃-hydroxyalkyl groups, for example 2-hydroxyethyl acrylate, 2-hydroxyethyl methacrylate, 3-hydroxypropyl acrylate, 3-hydroxypropyl methacrylate, 4-hydroxybutyl acrylate, and/or 4-hydroxybutyl methacrylate. It is particularly advantageous to use one or more, preferably one or two, of the following monomers M₁: 2-hydroxyethyl acrylate, 2-hydroxyethyl methacrylate, glycidyl acrylate, glycidyl methacrylate.

In the invention it is optionally possible to use some of, or the entirety of, monomers M₁ as initial charge in the polymerization vessel. However, it is also possible to meter the entirety or the optionally remaining residual quantity of monomers M₁ into the mixture during the polymerization reaction. The manner in which the entirety or the optionally remaining residual quantity of monomers M₁ is metered into the polymerization vessel here can be batchwise in one or more portions, or continuous with flow rates that remain the same or that alter. It is particularly advantageous that the metering of the monomers M₁ takes place continuously during the polymerization reaction, with flow rates that remain the same, in particular as constituent of an aqueous monomer emulsion.

Monomer(s) M₂ that can be used are in particular ethylenically unsaturated compounds that are easily copolymerizable with monomer(s) M₁ by a radical route, for example ethylene; vinylaromatic monomers such as styrene, α-methylstyrene, o-chlorostyrene, or vinyltoluenes; vinyl halides such as vinyl chloride or vinylidene chloride; esters derived from vinyl alcohol and from monocarboxylic acids having from 1 to 18 C atoms, for example vinyl acetate, vinyl propionate, vinyl n-butyrate, vinyl laurate, and vinyl stearate; esters derived from α,β-monoethylenically unsaturated mono- and dicarboxylic acids having preferably from 3 to 6 C atoms, particular examples being acrylic acid, methacrylic acid, maleic acid, fumaric acid, and itaconic acid, with alkanols generally having from 1 to 12, preferably from 1 to 8, and in particular from 1 to 4, C atoms, particular examples being the methyl, ethyl, n-butyl, isobutyl, pentyl, hexyl, heptyl, octyl, nonyl, decyl, and 2-ethylhexyl esters of acrylic acid and of methacrylic acid, the dimethyl or di-n-butyl esters of fumaric and of maleic acid; nitriles of α,β-monoethylenically unsaturated carboxylic acids, for example acrylonitrile, methacrylonitrile, fumaronitrile, maleonitrile, and also C₄- to C₈-conjugated dienes, such as 1,3-butadiene and isoprene. The monomers mentioned generally form the main monomers, and these combine to form a proportion of >50% by weight, preferably >80% by weight, and particularly >90% by weight, based on the entirety of the monomers M₂. The solubility of these monomers in water under standard conditions (20° C., 1 atm (absolute)) is very generally only moderate to low.

Monomers M₂ which have higher water solubility under the abovementioned conditions are those which comprise at least one acid group and/or anion corresponding thereto or at least one amino, amido, ureido, or N-heterocyclic group, and/or nitrogen-protonated or -alkylated ammonium derivatives thereof. Mention may be made by way of example of α,β-monoethylenically unsaturated mono- and dicarboxylic acids having from 3 to 6 C atoms and amides thereof, e.g. acrylic acid, methacrylic acid, maleic acid, fumaric acid, itaconic acid, acrylamide, and methacrylamide; and also of vinylsulfonic acid, 2-acrylamido-2-methylpropanesulfonic acid, styrenesulfonic acid, and water-soluble salts thereof, and also N-vinylpyrrolidone; 2-vinylpyridine, 4-vinylpyridine; 2-vinylimidazole; 2-(N,N-dimethylamino)ethyl acrylate, 2-(N,N-dimethylamino)ethyl methacrylate, 2-(N,N-diethylamino)ethyl acrylate, 2-(N,N-diethylamino)ethyl methacrylate, 2-(N-tert-butylamino)ethyl methacrylate, N-(3-N′,N′-dimethylaminopropyl)methacrylamide, and 2-(1-imidazolin-2-onyl)ethyl methacrylate and ureido methacrylate. The abovementioned water-soluble monomers M₂ are usually comprised merely as modifying monomers in quantities of <10% by weight, preferably <5% by weight, and particularly preferably <3% by weight, based on the entirety of monomers M₂.

Monomers M₂, which usually increase the internal strength of the filmed polymer matrix, normally have at least one N-methylol, or carbonyl group, or at least two non-conjugated ethylenically unsaturated double bonds. Examples here are monomers having two vinyl moieties, monomers having two vinylidene moieties, and also monomers having two alkenyl moieties. Particularly advantageous monomers here are the diesters of dihydric alcohols with α,β-monoethylenically unsaturated monocarboxylic acids, and among these preference is given to acrylic and methacrylic acid. Examples of monomers of this type having two non-conjugated ethylenically unsaturated double bonds are alkylene glycol diacrylates and alkylene glycol dimethacrylates, for example ethylene glycol diacrylate, propylene 1,2-glycol diacrylate, propylene 1,3-glycol diacrylate, butylene 1,3-glycol diacrylate, butylene 1,4-glycol diacrylates and ethylene glycol dimethacrylate, propylene 1,2-glycol dimethacrylate, propylene 1,3-glycol dimethacrylate, butylene glycol 1,3-dimethacrylate, butylene glycol 1,4-dimethacrylate, and also divinylbenzene, vinyl methacrylate, vinyl acrylate, allyl methacrylate, allyl acrylate, diallyl maleate, diallyl fumarate, methylenebisacrylamide, cyclopentadienyl acrylate, triallyl cyanurate, and triallyl isocyanurate. Examples of other compounds of importance in this context are diacetoneacrylamide and acetylacetoxyethyl acrylate and the corresponding methacrylate. Quantities used of the abovementioned crosslinking monomers M₂ are frequently <10% by weight, preferably <5% by weight, and particularly preferably <3% by weight, each based on the entirety of monomers M₂. However, the quantity of these crosslinking monomers M₂ used is frequently zero.

In the invention it is optionally possible to use some of, or the entirety of, monomers M₂ as initial charge in the polymerization vessel. However, it is also possible to meter the entirety or the optionally remaining residual quantity of monomers M₂ into the mixture during the polymerization reaction. The manner in which the entirety or the optionally remaining residual quantity of monomers M₂ is metered into the polymerization vessel here can be batchwise in one or more portions, or continuous with flow rates that remain the same or that alter. It is particularly advantageous that the metering of the monomers M₂ takes place continuously during the polymerization reaction, with flow rates that remain the same, in particular as constituent of an aqueous monomer emulsion.

Production of the aqueous dispersion of component (II) frequently makes concomitant use of dispersing agents which stabilize, in the aqueous phase, dispersion not only of the monomer droplets but also of the polymer particles obtained via the radical-initiated polymerization reaction, and thus ensure that the resultant aqueous polymer composition is stable. These can be not only the protective colloids usually used in the conduct of radical aqueous emulsion polymerization reactions, but also emulsifiers.

Examples of suitable protective colloids are polyvinyl alcohols, cellulose derivatives or copolymers comprising vinylpyrrolidone and comprising acrylic acid, for example those defined herein as component I(i). A detailed description of other suitable protective colloids is found in Houben-Weyl, Methoden der organischen Chemie, vol. XIV/1, Makromolekulare Stoffe [Macromolecular Compounds], pp. 411 to 420, Georg-Thieme-Verlag, Stuttgart, 1961.

It is also possible, of course, to use mixtures of emulsifiers and/or protective colloids. Dispersing agents frequently used comprise exclusively emulsifiers, the relative molecular weights of these usually being below 1000, in contrast to protective colloids. They can be either anionic, cationic, or nonionic. When mixtures of surface-active substances are used, the individual components must, of course, be compatible with one another, and in case of doubt this can be checked by a few preliminary experiments. Anionic emulsifiers are generally compatible with one another and with nonionic emulsifiers. The same also applies to cationic emulsifiers, whereas anionic and cationic emulsifiers are mostly not compatible with one another.

Examples of familiar emulsifiers are ethoxylated mono-, di-, and trialkylphenols (number of EO units: from 3 to 50, alkyl moiety: C₄ to C₁₂), ethoxylated fatty alcohols (number of EO units: from 3 to 50; alkyl moiety: C₈ to C₃₆), and also the alkali metal and ammonium salts of alkyl sulfates (alkyl moiety: C₈ to C₁₂), of sulfuric hemiesters of ethoxylated alkanols (number of EO units: from 3 to 30, alkyl moiety: C₁₂ to C₁₆), and ethoxylated alkylphenols (number of EO units: from 3 to 50, alkyl moiety: C₄ to C₁₂), of alkylsulfonic acids (alkyl moiety: C₁₂ to C₁₈), and of alkylarylsulfonic acids (alkyl moiety: C₉ to C₁₈). Other suitable emulsifiers are found in Houben-Weyl, Methoden der organischen Chemie, vol. XIV/1, Makromolekulare Stoffe [Macromolecular Compounds], pp. 192 to 208, Georg-Thieme-Verlag, Stuttgart, 1961.

Preference is given to use of nonionic and/or anionic emulsifiers for the process of the invention.

The quantity of dispersing agent, in particular emulsifiers, used is generally from 0.1 to 5% by weight, preferably from 1 to 3% by weight, based in each case on the entirety of the monomer mixture M. If protective colloids are used as sole dispersing agents, the quantity used is markedly higher; it is usual to use from 5 to 40% by weight of dispersing agent, preferably from 10 to 30% by weight, based in each case on the entirety of the monomer mixture M.

In the invention it is optionally possible to use some of, or the entirety of, dispersing agent as initial charge in the polymerization vessel. However, it is also possible to meter the entirety or the optionally remaining residual quantity of dispersing agent into the mixture during the polymerization reaction. The manner in which the entirety or the optionally remaining residual quantity of dispersing agent is metered into the polymerization vessel here can be batchwise in one or more portions, or continuous with flow rates that remain the same or that alter. It is particularly advantageous that the metering of the dispersing agent takes place continuously during the polymerization reaction, with flow rates that remain the same, in particular as constituent of an aqueous monomer emulsion.

Preferred monomers M comprise a) from 0.01 to 50% by weight of at least one ethylenically unsaturated monomer which comprises at least one epoxy group and/or at least one hydroxyalkyl group (monomer(s) M₁), and b) from 50 to 99.99% by weight of at least one other ethylenically unsaturated monomer which differs from the monomers M₁ (monomer(s) M₂).

Particularly preferred polymers M of this type are obtainable via free-radical-initiated solution polymerization of from 10 to 30% by weight, preferably from 15 to 22% by weight, of acrylic and/or methacrylic esters of C₁- to C₈-alcohols—preferably methanol, n-butanol, 2-ethylhexanol—with from 40 to 70% by weight, preferably from 55 to 65% by weight, of styrene, and from 5 to 50% by weight, preferably from 20 to 30% by weight, of 2-hydroxyethyl acrylate and/or 2-hydroxyethyl methacrylate, and/or glycidyl acrylate and/or glycidyl methacrylate, where the entirety of the components is 100% by weight.

Other preferred polymers M comprise no monomer(s) M₁, and are obtainable via radical-initiated solution polymerization of from 80 to 99% by weight, preferably from 85 to 95% by weight, of acrylic and/or methacrylic esters of C₁- to C₈-alcohol—preferably methanol, n-butanol, 2-ethylhexanol—with from 0 to 5% by weight, preferably from 1 to 3% by weight, of ureidomethacrylate and from 0.5 to 5% by weight, preferably from 1 to 4% by weight, of α,β-monoethylenically unsaturated mono- and dicarboxylic acids having from 3 to 6 C atoms—preferably acrylic acid, methacrylic acid—and/or amides of these acids, where the entirety of the components is 100% by weight.

Other preferred polymers M are obtainable via use of dispersing agents based on poly(acrylic acid)(s) as described in EP-A-1240205 or DE-A-19991049592.

It is preferable that these polymers have a core-shell structure (isotropic distribution of the phases, for example resembling layers in an onion) or a Janus structure (anisotropic distribution of the phases).

It is possible in the invention for the person skilled in the art to produce, via controlled variation of type and quantity of the monomers M₁ and M₂, aqueous polymer compositions with polymers M having a glass transition temperature T_{g} or a melting point in the range from (-60) to 270° C.

Other suitable aqueous dispersions are dispersions selected from the group of the polyurethanes, the halogenated vinyl polymers, the vinyl alcohol polymers and/or vinyl ester polymers, rubber, colophony resins, and hydrocarbon resins. Dispersions of this type are obtainable commercially, an example being Vinnepas® ethylene-vinyl acetate dispersions from Wacker or Tacylon colophony resins from Eastman Chemical Company. Preference is given to aqueous dispersions of aliphatic and aromatic polyurethanes, of polyvinyl acetate homo- and copolymers, and to terpentine resins and hydrocarbon resins.

Where the binder G) consists of two or more components G1), G2), etc., these components can be added prior to the addition to the lignocellulose particles LCP-2) or to the mixture of lignocellulose particles LCP-2), and other components, individually or in (partial) mixtures (e.g., in the case of three components, first G1), and then a mixture of G2) and G3), or alternatively a mixture of G1), G2), and G3)). These combinations preferably comprise an amino resin and/or phenolic resin. More preferably the binder G) consists of one or more components, in particular one component, selected from the group of the amino resins.

In one preferred embodiment, a combination of amino resin and isocyanate can be used as binder of component G). In this case, the total dry mass of the amino resin in the binder of component G), based on the total dry mass of the lignocellulose particles LCP-2), is in the range from 3 to 20 wt %, more preferably from 5 to 13 wt %, very preferably 7 to 11 wt %. The total amount of organic isocyanate, preferably of the oligomeric isocyanate having 2 to 10, preferably 2 to 8, monomeric units and on average at least one isocyanate group per monomer unit, more preferably PMDI, in this case, relative to the total dry mass of the core, is in the range from 0.05 to 5 wt %, preferably 0.1 to 3.5 wt %, more preferably 0.2 to 1 wt %, very preferably 0.25 to 0.5 wt %.

Component D) and H)

Components D) and H) may each independently of one another comprise identical or different, preferably identical, curing agents that are known to the skilled person, or mixtures of these agents. These curing agents are added preferably to component B), and/or to component G), where component G) comprises binders selected from the groups of the amino resins and of the phenolic resins.

Curing agents for the amino resin component or for the phenolic resin component here are all chemical compounds of any molecular weight that bring about or accelerate the polycondensation of amino or phenolic resin. One highly suitable group of curing agents for amino resins or phenolic resins are organic acids, inorganic acids, acidic salts of organic acids, and acidic salts of inorganic acids, or acid-forming salts such as ammonium salts, or acidic salts of organic amines. The components of this group can of course also be used in mixtures. Examples are ammonium sulfate or ammonium nitrate or inorganic or organic acids, as for example sulfuric acid, formic acid, or acid-regenerating substances, such as aluminum chloride, aluminum sulfate, or mixtures thereof. One preferred group of the curing agents for amino resin or phenolic resin are inorganic or organic acids such as nitric acid, sulfuric acid, formic acid, acetic acid, and polymers having acid groups, such as homopolymers or copolymers of acrylic or methacrylic or maleic acids.

Where acids are used, examples being mineral acids such as sulfuric acid or organic acids such as formic acid, the mass of acid relative to the total dry weight of lignocellulose particles LCP-1) and/or LCP-2), is preferably 0.001 to 1 wt %, preferably 0.01 to 0.5 wt %, more preferably 0.02 to 0.1 wt %.

Particularly preferred for use are curing agents which exhibit latent curing (M. Dunky, P. Niemz, Holzwerkstoffe and Leime, Springer 2002, pages 265 to 269), referred to as latent curing agents. Latent here means that the curing reaction does not occur immediately after the mixing of the amino resin and the curing agent, but only with a delay, or after activation of the curing agent by means of temperature, for example. The delayed curing increases the processing life of an amino resin/curing agent mixture. For the mixture of the lignocellulose particles with amino resin, curing agent, and the other components, as well, the use of latent curing agent may also have advantageous consequences, since it may result in less premature curing of the amino resin before process step iv). Preferred latent curing agents are as follows: ammonium chloride, ammonium bromide, ammonium iodide, ammonium sulfate, ammonium sulfite, ammonium hydrogensulfate, ammonium methanesulfonate, ammonium-p-toluenesulfonate, ammonium trifluoromethanesulfonate, ammonium nonafiuorobutanesulfonate, ammonium phosphate, ammonium nitrate, ammonium formate, ammonium acetate, morpholinium chloride, morpholinium bromide, morpholinium iodide, morpholinium sulfate, morpholinium sulfite, morpholinium hydrogensulfate, morpholinium methanesulfonate, morpholinium-p-toluenesulfonate, morpholinium trifluoromethanesulfonate, morpholinium nonafiuorobutanesulfonate, morpholinium phosphate, morpholinium nitrate, morpholinium formate, morpholinium acetate, monoethanolammonium chloride, monoethanolammonium bromide, monoethanolammonium iodide, monoethanolammonium sulfate, monoethanolammonium sulfite, monoethanolammonium hydrogensulfate, monoethanolammonium methanesulfonate, monoethanolammonium p-toluenesulfonate, monoethanolammonium trifluoromethanesulfonate, monoethanolammonium nonafiuorobutanesulfonate, monoethanolammonium phosphate, monoethanolammonium nitrate, monoethanolammonium formate, monoethanolammonium acetate, or mixtures thereof, preferably ammonium sulfate, ammonium nitrate, ammonium chloride, or mixtures thereof, more preferably ammonium sulfate, ammonium nitrate, or mixtures thereof.

Where these latent curing agents are used, the mass of these latent curing agents used, relative to the total dry weight of lignocellulose particles LCP-1) and/or LCP-2), is preferably 0.001 to 5 wt %, more preferably 0.01 to 0.5 wt %, very preferably 0.1 to 0.5 wt %.

Phenolic resins, preferably phenol-formaldehyde resins, can also be cured alkalinically, in which case preference is given to using carbonates or hydroxides such as potassium carbonate or sodium hydroxide.

Further examples of curing agents for amino resins are known from M. Dunky, P. Niemz, Holzwerkstoffe und Leime, Springer 2002, pages 265 to 269, and further examples of curing agents of phenolic resins, preferably phenol-formaldehyde resins, are known from M. Dunky, P. Niemz, Holzwerkstoffe und Leime, Springer 2002, pages 341 to 352.

Components E) and I):

Components E) and I) may be selected from the group of surfactants and/or from the group of other additives known to the skilled person, examples being hydrophobizing agents such as paraffin emulsions, antifungal agents, formaldehyde scavengers, exemplified by urea or polyamines, flame retardants, solvents such as, for example, alcohols, glycols or glycerol, metals, carbon, and alkali metal salts or alkaline earth metal salts from the group of the sulfates, nitrates, phosphates, or halides, or mixtures thereof. It is possible independently of one another to use identical or different, preferably identical, additives in amounts of 0 to 5 wt %, preferably 0.5 to 4 wt %, more preferably 1 to 3 wt %, based on the total dry amount of the lignocellulose particles LCP-1) and/or LCP-2).

Suitable surfactants are anionic, cationic, nonionic, or amphoteric surfactants, and mixtures thereof.

Examples of surfactants are listed in McCutcheon's, vol. 1: Emulsifiers & Detergents, McCutcheon's Directories, Glen Rock, USA, 2008 (International Ed. or North American Ed.).

Suitable anionic surfactants are alkali metal, alkaline earth metal, or ammonium salts of sulfonates, sulfates, phosphates, carboxylates, or mixtures thereof. Examples of sulfonates are alkylarylsulfonates, diphenylsulfonates, α-olefinsulfonates, lignosulfonates, sulfonates of fatty acids and oils, sulfonates of ethoxylated alkylphenols, sulfonates of alkoxylated arylphenols, naphthalenesulfonate condensates, dodecyl- and tridecylbenzenesulfonates, naphthalene- and sikyl-naphthalenesulfonates or sulfosuccinates. Examples of sulfates are sulfates of fatty acids and oils, ethoxylated alkylphenol sulfates, alcohol sulfates, sulfates of ethoxylated alcohols, or fatty acid ester sulfates.

Suitable nonionic surfactants are alkoxylates, N-substituted fatty acid amides, amine oxides, esters, sugar-based surfactants, polymeric surfactants, block polymers, and mixtures thereof. Examples of alkoxylates are compounds such as alcohols, alkylphenols, amines, amides, arylphenols, fatty acids or fatty acid esters, having been alkoxylated with 1 to 50 equivalents of alkylene oxide. Ethylene oxide and/or propylene oxide can be used for the alkoxylation, preferably ethylene oxide. Examples of N-substituted fatty acid amides are fatty acid glucamides or fatty acid alkanolamides. Examples of esters are fatty acid esters, glycerol esters, or monoglycerides. Examples of sugar-based surfactants are sorbitan, ethoxylated sorbitans, sucrose esters and glycose esters, or alkylpolyglucosides. Examples of polymeric surfactants are homopolymers or copolymers of vinylpyrrolidone, vinyl alcohol, or vinyl acetate. Suitable block polymers are block polymers of A-B or A-B-A type comprising blocks of polyethylene oxide and polypropylene oxide, or of A-B-C type comprising alkanol and blocks of polyethylene oxide and polypropylene oxide.

Suitable cationic surfactants are quaternary surfactants, examples being quaternary ammonium compounds having one or two hydrophobic groups, or ammonium salts of long-chain primary amines.

Suitable amphoteric surfactants are alkylbetaines and imidazolines.

Particularly preferred surfactants are fatty alcohol polyglycol ethers, fatty alcohol sulfates, sulfonated fatty alcohol polyglycol ethers, fatty alcohol ether sulfates, sulfonated fatty acid methyl esters, sugar surfactants, such as alkylglycosides, alkylbenzenesulfonates, alkanesulfonates, methyl ester sulfonates, quaternary ammonium salts, such as cetyltrimethylammonium bromide, for example, and soaps.

Components F) and J):

Component F) and component J) may be selected independently of one another from the group of the trialkyl phosphates or mixtures thereof. In the case of single-layer lignocellulosic materials or in the case of multilayer lignocellulosic materials in the core, use is made, for the mixture in process step I), of 0.01 to 10 wt %, preferably 0.01 to 5 wt %, more preferably 0.01 to 2 wt % of trialkyl phosphate, based on the total dry content of the lignocellulose particles LCP-1), as component F). For the outer layers in the case of multilayer lignocellulosic materials, use is made, for the mixture in process step i), of 0 to 10 wt %, preferably 0 to 2 wt %, more preferably 0 to 0.1 wt % of trialkyl phosphate, as component J). With very particular preference there is no trialkyl phosphate used in the mixtures for the outer layers.

Suitable trialkyl phosphates are compounds with the structure R₃PO₄, with each of the three (3) radicals R being able independently of any other to be an alkyl group having 1, 2, 3, 4, 5, or 6 carbon atoms. Each group R may have the same or a different number, preferably the same number, of carbon atoms. In the case of the same number of carbon atoms, the groups may either be the same or may be isomeric groups, preferably the same groups.

For example, use may be made of trimethyl phosphate, triethyl phosphate, triproplyl phosphate, tributyl phosphate, tripentyl phosphate, trihexyl phosphate or mixtures thereof, preferably trimethyl phosphate, triethyl phosphate, tripropyl phosphate or mixtures thereof, very preferably triethyl phosphate.

The trialkyl phosphates are used in general as a liquid or as a solution. In a further particular embodiment, the trialkyl phosphates are mixed with components B), C) and/or G), preferably with components B) and/or C), more preferably with component B) or component C), very preferably with component B), before being mixed with the lignocellulose particles.

Use:

The process of the invention can be used to produce single-layer and multilayer lignocellulosic materials of a wide variety of kinds, particular preference being given to single-layer and multilayer particle board and fiberboard and oriented strand boards (OSB), very preferably single-layer particle board and fiberboard and multilayer particle board, more particularly multilayer particle boards.

The overall thickness of the multilayer lignocellulosic materials of the invention varies with the field of application and is situated generally in the range from 0.5 to 100 mm, preferably in the range from 10 to 40 mm, more particularly 15 to 20 mm.

The single-layer and multilayer lignocelluosic materials of the invention generally have an average overall density of 100 to 1000 kg/m³, preferably 400 to 850 kg/m³.

The multilayer particle board of the invention generally has an average overall density of from 400 to 750 kg/m³, more preferably 425 to 650 kg/m³, more particularly 450 to 600 kg/m³. The density is determined 24 h hours after production in accordance with EN 1058.

The lignocellulosic materials produced by the process of the invention, especially single-layer and multilayer particle board and single-layer fiberboard, are used in particular in construction, in the fitting-out of interiors, in shopfitting and the construction of exhibition stands, as material for furniture, and as packaging material.

In a preferred use, the lignocellulosic materials produced by the process of the invention are used as interior plies for sandwich panels. In that case the outer plies of the sandwich panels may consist of various materials, as for example of metals such as aluminum or stainless steel, or of thin plates of wood base material, such as particle board or fiberboard plates, preferably highly compacted fiberboard (HDF), or of laminates such as high-pressure laminate (HPL), for example.

In a further preferred use, the lignocellulosic materials produced by the process of the invention are coated on one or more sides, with furniture foils, with melamine films, with veneers, with plastic edging, or with a surface coating, for example.

In construction, the fitting-out of interiors, shopfitting and the construction of exhibition stands, the lignocellulosic materials produced in accordance with the invention, or the coated lignocellulosic materials produced from them, or the sandwich panels produced from these materials, are used, for example, as roof paneling and wall paneling, infill, shuttering, floors, internal layers for doors, partitions, or shelving.

In furniture construction, the lignocellulose materials produced by the process of the invention, or the coated lignocellulosic materials produced from them, or the sandwich panels produced from these lignocellulosic materials, are used, for example, as support materials for unit furniture, as shelving, as door material, as worktop, as kitchen front, as elements in tables, chains, and upholstered furniture.

### EXAMPLES

Production of the Boards

Glue used was a urea-formaldehyde glue (Kaurit® Leim 337 from BASF SE). The solids content was adjusted with water to 64.2 wt %. Lupranat® M 20 FB from BASF SE was used as pMDI component.

Production of Chip Material for the Inventive Particle Board (Resination)

In a mixer, 5.4 kg of spruce chips (middle-layer chips) were mixed with 1 kg of a mixture of 100 parts by weight of Kaurit® Leim 337, 4 parts by weight of a 52% strength aqueous ammonium nitrate solution, and 15 parts of water. Then 21.6 g of a mixture of 3 parts by weight of pMDI and one part by weight of triethyl phosphate were applied in the mixer.

Pressing of the Chip Material

950 g of resinated chips, either immediately or after a waiting time of 15 minutes, were scattered into a mold measuring 30×30 cm, and subjected to cold precompaction. Thereafter the resulting precompacted chip mat was pressed to particle board in a hot press, to a thickness of 16 mm (pressing temperature 210° C., pressing time 100 s).

Investigation of the Particle Board

The transverse tensile strength was determined according to EN 319.

The thickness swelling after 24 hours was determined according to EN 317.

The perforator value as a measure of formaldehyde emission was determined according to EN 120.

The results of the tests are compiled in the table.

The quantity figures are based always on 100 wt % dry weight of woodchips. The density of the two boards was 550 kg/m³.

| | Kaurit Leim 337 | Lupranat M 20 FB | TEP | Waiting |
|---|---|---|---|---|
| | [% based on | [% based on | [% based on | time |
| Test | atro wood] | atro wood] | atro wood] | [min] |
| 1 | 10 | 0.3 | 0.1 | 0 |
| 2 | 10 | 0.3 | 0.1 | 15 |

| | Transverse | Thickness swelling | Perforator value |
|---|---|---|---|
| | tensile strength | after 24 h | according to EN120 |
| Test | [N/mm²] | [%] | [mg/100 g] |
| 1 | 0.60 | 20.6 | 6.8 |
| 2 | 0.58 | 21.5 | 7.7 |

1-14. (canceled)

15. A process for the discontinuous or continuous, preferably continuous, production of single-layer or multilayer lignocellulosic materials, comprising the process steps of
i) mixing the components of the individual layers,
ii) scattering the mixture(s) produced in process step i) to form a mat,
iii) precompacting the scattered mat, and
iv) hot pressing the precompacted mat,
which comprises, in process step i)
for the core of multilayer lignocellulosic materials or for single-layer lignocellulosic materials, mixing the lignocellulose particles (component LCP-1) with
a) 0 to 25 wt % of expanded polymer particles having a bulk density in the range from 10 to 150 kg/m³ (component A),
b) 0.05 to 1.39 wt % of binders selected from the group of organic isocyanates having at least two isocyanate groups (component B),
c) 3 to 20 wt % of binders selected from the group of amino resins (component C),
d) 0 to 5 wt % of curing agents (component D),
e) 0 to 5 wt % of additives (component E),
f) 0.01 to 10 wt % of trialkyl phosphate (TAP) (component F), and
for the outer layers of multilayer lignocellulosic materials, mixing the lignocellulose particles (component LCP-2) with
g) 1 to 30 wt % of binders selected from the group of amino resins, phenolic resins, organic isocyanates having at least two isocyanate groups, protein-based binders, and other polymer-based binders (component G),
h) 0 to 5 wt % of curing agents (component H),
i) 0 to 5 wt % of additives (component: I), and
j) 0 to 10 wt % of trialkyl phosphate (TAP) (component J).

16. The process for producing single-layer or multilayer lignocellulosic materials according to claim 15, wherein the process is carried out continuously.

17. The process for producing multilayer or single-layer lignocellulosic materials according to claim 15, wherein the lignocellulosic materials comprise, in the core or in the sole layer, respectively, 0.5 to 7.5 wt % of component F) or mixtures thereof.

18. The process for producing multilayer or single-layer lignocellulosic materials according to claim 15, wherein component F) used comprises trimethyl phosphate, triethyl phosphate, tripropyl phosphate, tributyl phosphate, tripentyl phosphate, trihexyl phosphate, or mixtures thereof.

19. The process for producing multilayer or single-layer lignocellulosic materials according to claim 15, wherein component F) used comprises triethyl phosphate.

20. The process for producing multilayer or single-layer lignocellulosic materials according to claim 15, wherein for the sole layer or the layer of the core, respectively, in process step i) component C) is mixed with component F) or with component D) and with components F), or with component D), with component E) and/or with a portion of component E) and of components F), in a separate step, before it is contacted with LCP-1) or with a mixture of LCP-1) with other components.

21. The process for producing multilayer or single-layer lignocellulosic materials according to claim 15, wherein for the sole layer or the layer of the core., in process step i) component C) is mixed with a portion of component F) or with component D) and with a portion of components F), or with component D), with component E) and/or with a portion of component E) and a portion of components F), and component B) is mixed with a portion of component F) or with component E) and/or with a portion of component E) and a portion of components F), in separate steps, before they are contacted with LCP-1) or with a mixture of LCP-1) with other components.

22. The process for producing multilayer or single-layer lignocellulosic materials according to claim 15, wherein component B), which has optionally been mixed in a separate step with one or more components selected from the groups of components D), E), and F), and component C), which has optionally been mixed in a separate step with one or more components selected from the groups of components D), E), and F), are added in process step i), either simultaneously or in succession, preferably simultaneously, to the lignocellulose particles LCP-1) or to the mixture of lignocellulose particles LCP-1) with other components.

23. The process for producing multilayer or single-layer lignocellulosic materials according to claim 15, wherein the lignocellulosic materials possess a density of 100 to 700 kg/m³, preferably 150 to 490 kg/m³, more preferably 200 to 440 kg/m³, more particularly 250 to 390 kg/m³.

24. A single-layer or multilayer lignocellulosic material having a core and optionally at least one upper outer layer and one lower outer layer, produced according to claim 15, in which the scattered layers comprise,
for the core of multilayer lignocellulosic materials or in single-layer lignocellulosic materials, lignocellulose particles (component LCP-1) mixed with
a) 0 to 25 wt % of expanded polymer particles having a bulk density in the range from 10 to 150 kg/m³ (component A),
b) 0.05 to 1.39 wt % of binders selected from the group of organic isocyanates having at least two isocyanate groups (component B),
c) 3 to 20 wt % of binders selected from the group of amino resins (component C),
d) 0 to 5 wt % of curing agents (component D),
e) 0 to 5 wt % of additives (component E), and
f) 0.01 to 10 wt % of trialkyl phosphate (TAP) or mixtures thereof (component F),
and for the outer layers of multilayer lignocellulosic materials, lignocellulose particles (component LCP-2) mixed with
g) 1 to 30 wt % of binders selected from the group of amino resins, phenolic resins, organic isocyanates having at least two isocyanate groups, protein-based binders, and
other polymer-based binders (component G),
h) 0 to 5 wt % of curing agents (component H),
i) 0 to 5 wt % of additives (component: I), and
j) 0 to 10 wt % of trialkyl phosphate (TAP) (component J).

25. The single-layer or multilayer lignocellulosic material according to claim 24, the core or the single layer of the lignocellulosic material comprising 0.5 to 7.5 wt % of component F) or mixtures thereof.

26. A single-layer or multilayer lignocellulosic material obtainable by the process according to claim 15.

27. The use of the single-layer or multilayer lignocellulosic material according to claim 15 in construction, in fitting-out of interiors, in shop fitting and the construction of exhibition stands, as material for furniture, or as packaging material.

28. The use of the single-layer and multilayer lignocellulosic material according to claim 15 as roof paneling and wall paneling, infill, shuttering, floors, internal layers for doors, partitions, shelving, or as support material for unit furniture, as shelving, as door material, as worktop, as kitchen front, as outer layers in sandwich structures, as elements in tables, chairs, and upholstered furniture.
